(19) United States
(12) Patent Application Publication
(10) Pub. No.: US 2025/0029286 A1
(43) Pub. Date: Jan. 23, 2025

(54) METHODS, SYSTEMS, AND COMPUTER PROGRAM PRODUCTS FOR DATACENTER VISUALIZATION

(71) Applicant: NVIDIA CORPORATION, Santa Clara, CA (US)

(72) Inventors: Siddha Ganju, Santa Clara, CA (US); Srikanth Cherukuri, Belmont, CA (US); Elad Mentovich, Tel Aviv (IL); Yoram Zer, Megido (IL); Ashrut Ambastha, Pune (IN); Jeremy Rodriguez, Santa Cruz, CA (US); Lior Ofer, Tel Mond (IL)

(21) Appl. No.: 18/223,229

(22) Filed: Jul. 18, 2023

(51) Int. Cl. G06T 11/00; H04L 43/045

(52) U.S. Cl. CPC G06T 11/00; H04L 43/045

(57) ABSTRACT

Systems, methods, and computer program products are provided for datacenter visualization. An example method includes receiving a request for datacenter visualization that is associated with a plurality of datacenter computing components of a physical datacenter installation. The method includes determining one or more installation characteristics associated with the physical datacenter installation and determining one or more performance parameters associated with the physical datacenter installation based at least in part on the one or more installation characteristics. The method further includes generating the datacenter visualization for presentation to a user associated with the request. The datacenter visualization is a digital representation of the physical datacenter installation that further includes a visual representation of the performance parameters associated with the plurality of datacenter computing components.

### TECHNOLOGICAL FIELD

Embodiments of the present disclosure relate generally to networking and computing systems, and, more particularly, to the generation of datacenter visualizations that are digital representations of physical datacenter installations.

### BACKGROUND

Datacenters, high performance computing clusters, and/or the like are often formed of various computing components (e.g., graphics processing units (GPUs), servers, racks, switches, etc.). For example, a physical datacenter installation may be formed of a plurality of racks supporting GPUs each of which may have distinct operational capabilities. Through applied effort, ingenuity, and innovation, many of the problems associated with conventional networking and computing systems have been solved by developing solutions that are included in embodiments of the present disclosure, many examples of which are described in detail herein.

### BRIEF SUMMARY

Embodiments of the present disclosure provide for methods, systems, apparatuses, and computer program products for datacenter visualization. With reference to an example computer-implemented method, the method may include receiving a request for datacenter visualization that may be associated with a plurality of datacenter computing components of a physical datacenter installation. The method may include determining one or more installation characteristics associated with the physical datacenter installation and determining one or more performance parameters associated with the physical datacenter installation based at least in part on the one or more installation characteristics. The method may further include generating the datacenter visualization for presentation to a user associated with the request. The datacenter visualization may be a digital representation of the physical datacenter installation that further includes a visual representation of the performance parameters associated with the plurality of datacenter computing components.

In some embodiments, the method may further include rendering the datacenter visualization in a virtual reality (VR) environment.

In other embodiments, the method may include rendering the datacenter visualization as an augmented reality (AR) overlay via a user device associated with the user.

In some embodiments, generating the datacenter visualization may further include accessing one or more initial installation arrangements and modifying the one or more initial installation arrangements based upon the one or more installation characteristics associated with the physical datacenter installation.

In some embodiments, the method may further include receiving one or more modifications to the installation characteristics and dynamically modifying the datacenter visualization based upon the one or more modifications.

In some further embodiments, the method may include dynamically determining the one or more performance parameters associated with the physical datacenter installation in response to the one or more modifications to the installation characteristics.

In some still further embodiments, the one or more modifications to the installation characteristics are received via a user input directly within a virtual reality (VR) environment or an augmented reality (AR) overlay rendering the datacenter visualization.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings. The components illustrated in the figures may or may not be present in certain embodiments described herein. Some embodiments may include fewer (or more) components than those shown in the figures.

FIG. 1A illustrates an example physical datacenter installation in accordance with one or more example embodiments of the present disclosure;

FIG. 1B illustrates example datacenter computing components of the physical datacenter installation of FIG. 1A in accordance with one or more example embodiments of the present disclosure;

FIG. 2 illustrates an example distributed computing system for implementing one or more embodiments of the present disclosure;

FIG. 3 illustrates a block diagram of example server circuitry that may be specifically configured in accordance with an example embodiment of the present disclosure;

FIG. 4 illustrates a flowchart of an example method for datacenter visualization, in accordance with some embodiments of the present disclosure;

FIG. 5 illustrates a flowchart of an example method for installation arrangement and modification in accordance with some embodiments of the present disclosure; and

FIGS. 6A-6G illustrate example datacenter visualizations generated in accordance with one or more embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

As described above, datacenters, high performance computing clusters, and/or the like are often formed of various computing components (e.g., GPUs, servers, racks, switches, etc.) each of which may have distinct operational capabilities. In designing particular datacenter implementations, a user (e.g., customer, operator, etc.) may often determine the size of the datacenter installation (e.g., the number of required computing components) based upon the number of processes or jobs to be completed by the datacenter and/or the cost associated with the computing components or use of the same (e.g., power consumption, storage costs, etc.). In doing so, these traditional datacenter designs fail to properly account for the particular arrangement of the computing components in the subsequent physical installation of the datacenter (e.g., generated based upon the design). As such, conventional datacenter designs similarly fail to account for various characteristics (e.g., serviceability, thermal management capabilities, cabling configurations, and/or the like) of the physical datacenter installation. Furthermore, these conventional datacenter design systems and techniques fail to provide a mechanism for viewing the particular arrangement of computing components prior to installation or deployment of the physical datacenter installation.

In order to solve these problems and others, the embodiments of the present disclosure provide methods and systems for generating a visualization (e.g., digital twin) of a datacenter implementation in the pre-deployment stage that allows a user to review and modify the datacenter design to account for the serviceability, thermal management capabilities, cabling configurations, and/or any other characteristic of the physical datacenter installation. For example, the systems of the present disclosure may receive various installation characteristics (e.g., the number of GPUs, their physical location, etc.) and determine associated performance parameters (e.g., processing throughput, thermal burden, etc.). In response, a datacenter visualization may be generated that illustrates not only the physical location of the GPUs but also the performance parameters associated with the GPUs based upon their physical locations, connections, etc. This datacenter visualization may be rendered in an AR/VR environment in order to allow direct user interaction and modification in a digital representation of the datacenter design. Furthermore, the datacenter visualization may be used for training purposes for service professionals, operators, or the like.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present disclosure. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Example Physical Datacenter Installations

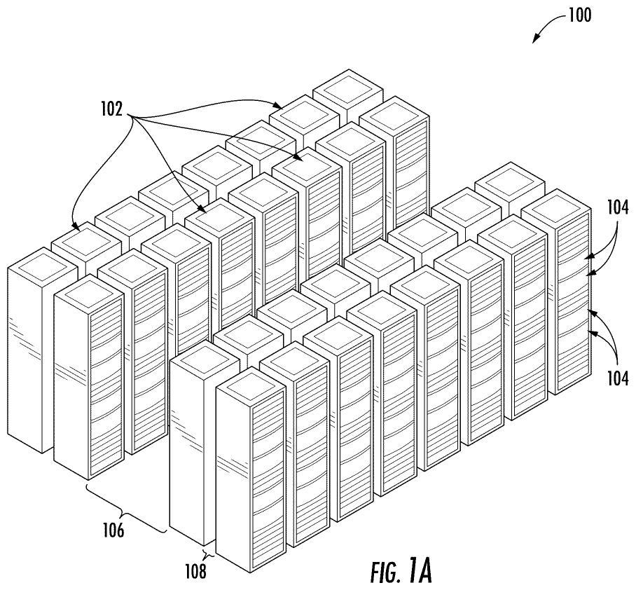

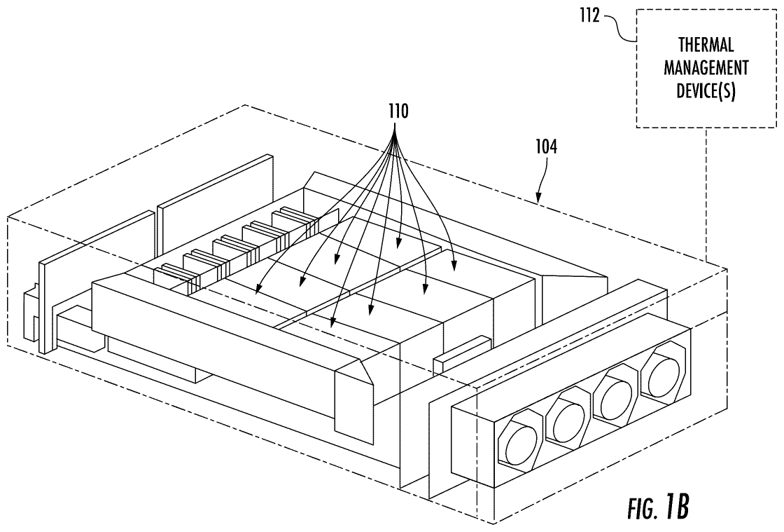

With reference to FIG. 1A, an example physical datacenter installation 100 (e.g., installation 100) is illustrated. As described above, physical datacenter installations 100, such as those that are employed in high performance computing clusters, may be formed of a plurality of datacenter computing components (e.g., central processing units (CPUs), data processing units (DPUs), GPUs, servers, racks, switches, etc.). As shown, the example physical datacenter installation 100 may include a plurality of racks 102 supporting or otherwise formed of one or more networking boxes 104 (e.g., servers, computing devices, etc.). As described hereafter with reference to FIG. 1B, the example networking boxes 104 may include various electrical components, optical components, computing devices, etc. (e.g., GPUs 110) for performing the operations associated with the physical datacenter installation 100. As would be evident by the modular nature of the components forming the physical datacenter installation, the arrangement of the various datacenter computing components that form the physical datacenter installation 100 may vary based upon the number or amount of datacenter computing components (e.g., racks 102, networking/computing boxes 104, GPUs, servers, etc.) and/or the features associated with the installation location (e.g., the size, shape, geometry, etc. associated with the location at which the datacenter is installed).

By way of example, a particular number of datacenter computing components (e.g., networking/computing boxes 104) associated with the installation 100 may at least partially determine the particular number of racks 102 to be used by the installation 100. Similarly, a distance 108 between racks 102 and/or a distance 106 between groups of racks 102 may at least partially depend upon the number of racks 102 used by the installation 100. Furthermore, these relative distances 106, 108 may also be impacted by the dimensions (e.g., size and/or shape) of the physical location at which the installation 100 is provided. By way of example, the particular geometric constraints associated with the location at which the installation 100 is installed may limit the distance 108 between racks 102, the number of racks 102 that may be included in a particular group, and/or the like. Although described herein with reference to an installation 100 that includes racks 102 of networking/computing boxes 104, the present disclosure contemplates that the physical datacenter installations described herein may include any number of components, housings, enclosures, support elements, electrical/optical cabling, thermal management components, etc. based upon the intended application of the installation 100.

With reference to FIG. 1B, and example networking/computing box 104 is illustrated as an example datacenter computing component of the installation 100. By way of example, the networking/computing box 104 may be a networking enclosure that supports a plurality of GPUs 110 as part of a high-performance computing system. In the example illustrated in FIG. 1B, the example networking/computing box 104 may support eight (8) GPUs 110; however, the present disclosure contemplates that the networking/computing box 104 may support any number of GPUs 110 at any position, location, orientation, etc. based upon the intended application of the installation 100. Although described herein with reference to GPU(s) as example datacenter computing components, the present disclosure contemplates that any device, element, feature, etc. (e.g., CPU, DPU, optical components, switches, and/or the like.) may be used by the installation 100 based upon the intended application of the physical datacenter installation. Furthermore, in order to provide optical and/or electrical connectivity to the datacenter computing components within the example networking/computing box 104, the networking/computing box 104 may include any number of printed circuit boards (PCBs), electrical traces, optical waveguides/fibers, etc. without limitation.

In some embodiments, the physical datacenter installation 100 may include one or more thermal management devices 112. As would be evident to one of ordinary skill in the art in light of the present disclosure, the datacenter computing components that are leveraged by the physical datacenter installation to perform its associated operations may generate heat during operation. In order to dissipate this heat (e.g., reduce the thermal burden), the thermal management devices 112 may include one or more air cooling components (e.g., fans, vortex tubes, pumps, plenums, etc.) that may cause air to be circulated (e.g., via one or more channels, ducts, conduits, etc.) to the plurality of datacenter computing components (e.g., GPUs 110 or the like) to selectively cause heat dissipation. Similarly, the thermal management devices 112 may include one or more fluid cooling components (e.g., pumps, radiators, water blocks, reservoirs, etc.) that cause fluid or liquid to be circulated (e.g., via one or more channels, ducts, conduits, etc.) to the plurality of datacenter computing components to selectively cause heat dissipation. Although described herein with reference to air and/or liquid cooling solutions, the present disclosure contemplates that any mechanism, structure, devices, etc. (e.g., heat sinks, heat exchangers, and/or the like) may be used by the thermal management devices 112 to dissipate heat generated the components described herein.

As described above, however, traditional datacenter design methods and systems fail to properly account for the particular arrangement of the computing components in the subsequent physical installation of the datacenter (e.g., generated based upon the design). As such, conventional datacenter designs similarly fail to account for various characteristics (e.g., serviceability, thermal management capabilities, cabling configurations, and/or the like) of the physical datacenter installation 100 during the design phase (e.g., prior to deployment). Furthermore, these conventional datacenter design systems and techniques fail to provide a mechanism for viewing the particular arrangement of computing components prior to installation or deployment of the physical datacenter installation 100. In doing so, these conventional systems fail to provide users (e.g., customers, operators, etc.) the ability to dynamically position (and reposition) particular datacenter computing components prior to deployment as described hereinafter.

### Example Datacenter Visualization Systems

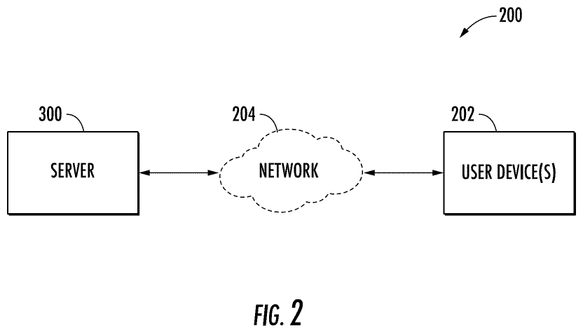

FIG. 2 illustrates a datacenter visualization system 200 (e.g., system 200) as an example system for generating datacenter visualizations (e.g., digital twins, digital representations, etc.) of physical datacenter installations. It will be appreciated that the system 200 is provided as an example of an embodiment(s) and should not be construed to narrow the scope or spirit of the disclosure. The depicted system 200 of FIG. 2 may include a server 300 (e.g., a datacenter visualization server) capable of receiving, generating, accessing, or otherwise generating datacenter visualizations that are digital representations of a physical datacenter installation. The server 300 may be further communicatively connected to one or more user device(s) 202 by a communication network 204. For example, the server 300 may be configured to generate a datacenter visualization as described hereafter and transmit this visualization to one or more user devices 202 for presentation to associated user(s).

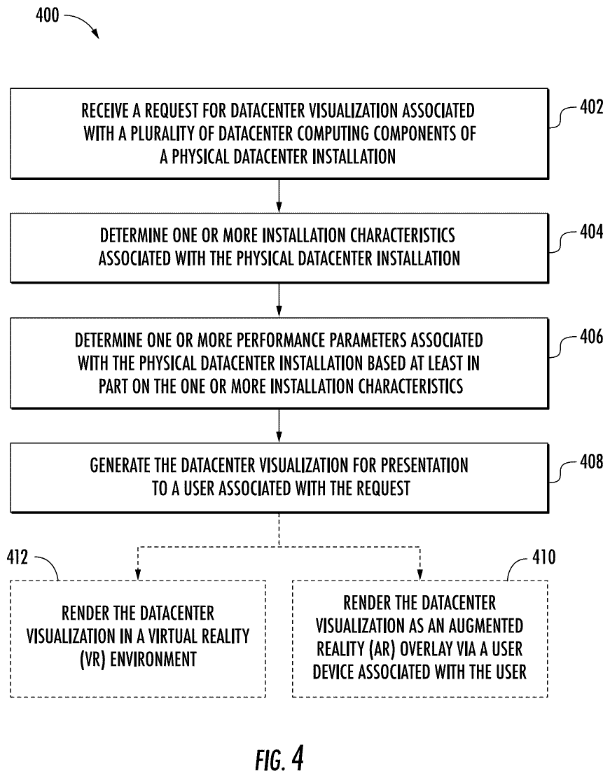

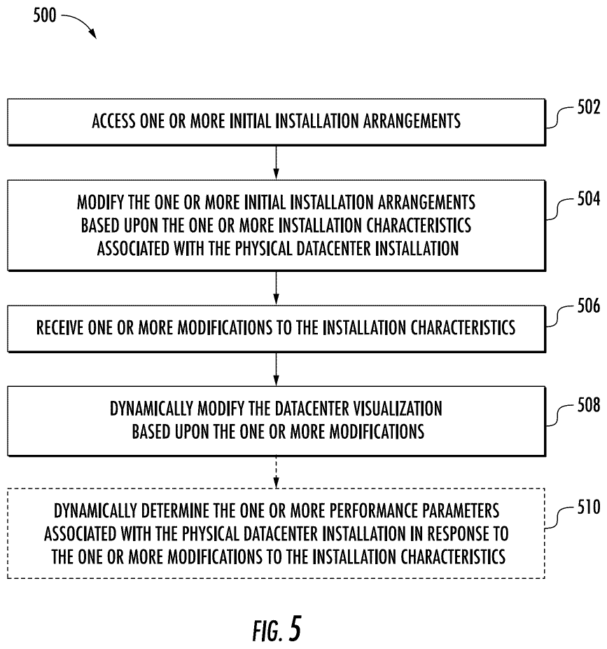

Although described hereinafter with reference to a server 300, the present disclosure contemplates that the operations described hereafter with reference to FIGS. 4-5 may be performed by any computing device, system orchestrator, central processing unit (CPU), graphics processing unit (GPU), data processing unit (DPU), and/or the like. Furthermore, although illustrated as a single device (e.g., server 300), the present disclosure contemplates that any number of distributed components may collectively be used to perform the operations described herein. The server 300 may be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware.

The system 200 may further include one or more user devices 202 as described above. The one or more user device 202 may refer to computer hardware that is configured (either physically or by the execution of software) to access one or more services made available by the server 300 and, among various other functions, is configured to directly, or indirectly, transmit and receive data. Example user devices may include a smartphone, a tablet computer, a laptop computer, a wearable device (e.g., smart glasses, smart watch, or the like), and the like. In some embodiments, a user device may include a “smart device” that is equipped with chip of other electronic device that is configured to communicate with the external device via Bluetooth, NFC, Wi-Fi, 3G, 4G, 5G, RFID protocols, and the like. By way of a particular example, a user device may be a mobile phone equipped with a Wi-Fi radio that is configured to communicate with a Wi-Fi access point that is in communication with the server 300 or other computing device via a network.

Each user device 202 may be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware. In some embodiments, one or more of the user devices 202 may be embodied on the same physical device as the server 300. In some embodiments, one or more of the user devices 202 may be remote to the system 200. Still, in some embodiments, one or more user devices 202 may be located on the same physical device as the system 200 and one or more user devices 202 may be remote to the system 200 and connected through the communication network 204.

In some embodiments, as described hereafter with reference to FIG. 4, the datacenter visualization generated by the server 300 may be rendered in a virtual reality (VR) environment and/or as an augmented reality (AR) overlay via a user device 202 associated with the user. In order to view the VR and/or AR rendering of the datacenter visualization, in some embodiments, the user device(s) 202 may include circuitry, components, modules, devices, and/or the like. As would be evident to one of ordinary skill in the art, “virtual reality” may refer to any simulated experience within which a user (e.g., a user associated with the user device(s) 202) may be at least partially immersed. For example, a virtual reality rendering may refer to a computer-generated environment within which a user may immersed and with which a user my interact, such as via one or more VR devices (e.g., VR headset, VR mounted displayed, etc.). As would be evident to one of ordinary skill in the art, “augmented reality” may refer to any simulated or interactive experience that includes computer-generated content in conjunction with the real world environment. For example, an augmented reality rendering may refer to computer-generated visual, auditory, and/or other sensor information that is overlayed over a user's (e.g., a user associated with the user device(s) 202) environment. The present disclosure contemplates that the user device(s) 202 may include any component, circuitry, device, etc. configured to render a datacenter visualization in a VR/AR environment based upon the intended application of the system 200.

The communication network 204 may be any means including hardware, software, devices, or circuitry that is configured to support the transmission of computer messages between system nodes. For example, the communication network 204 may be formed of components supporting wired transmission protocols, such as, digital subscriber line (DSL), Ethernet, fiber distributed data interface (FDDI), or any other wired transmission protocol obvious to a person of ordinary skill in the art. The communication network 204 may also be comprised of components supporting wireless transmission protocols, such as Bluetooth, IEEE 802.11 (Wi-Fi), or other wireless protocols obvious to a person of ordinary skill in the art. In addition, the communication network 204 may be formed of components supporting a standard communication bus, such as, a Peripheral Component Interconnect (PCI), PCI Express (PCIe or PCI-e), PCI extended (PCI-X), Accelerated Graphics Port (AGP), or other similar high-speed communication connection. Further, the communication network 204 may be comprised of any combination of the above mentioned protocols. In some embodiments, such as when the user device(s) 202 and the server 300 are formed as part of the same physical device, the communication network 204 may include the on-board wiring providing the physical connection between the component devices.

### Example Server Circuitry

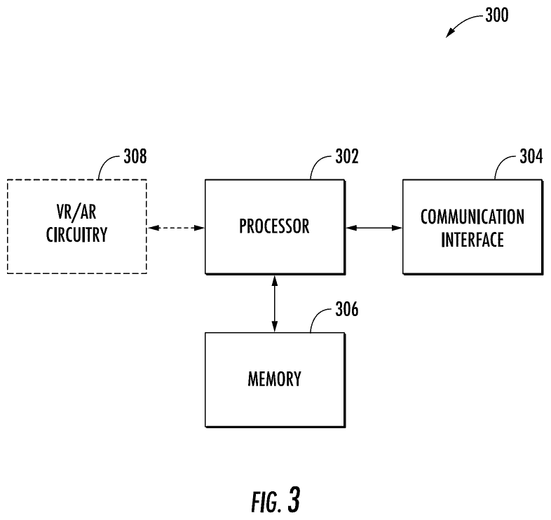

With reference to FIG. 3, example circuitry components of the server 300 are illustrated that may, alone or in combination with any of the components described herein, be configured to perform the operations described herein with reference to FIGS. 4-5. As shown, the server 300 may include, be associated with or be in communication with processor 302, a memory 306, and a communication interface 304. In some embodiments, the server 300 may include VR/AR circuitry 308. The processor 302 may be in communication with the memory 306 via a bus for passing information among components of the server 300. The memory 306 may be non-transitory and may include, for example, one or more volatile and/or non-volatile memories. In other words, for example, the memory 306 may be an electronic storage device (e.g., a computer readable storage medium) comprising gates configured to store data (e.g., bits) that may be retrievable by a machine (e.g., a computing device like the processing circuitry). The memory 306 may be configured to store information, data, content, applications, instructions, or the like for enabling the apparatus to carry out various functions in accordance with an example embodiment of the present disclosure. For example, the memory 306 could be configured to buffer input data for processing by the processor 302. Additionally or alternatively, the memory 306 could be configured to store instructions for execution by the processor 302.

The server 300 (e.g., example apparatus of the present disclosure) may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 302 may be embodied in a number of different ways. For example, the processor 302 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 302 may be configured to execute instructions stored in the memory 306 or otherwise accessible to the processor 302. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 302 is embodied as an executor of instructions, the instructions may specifically configure the processor to perform the algorithms and/or operations described herein when the instructions are executed. However, in some cases, the processor 302 may be a processor of a specific device configured to employ an embodiment of the present disclosure by further configuration of the processing circuitry by instructions for performing the algorithms and/or operations described herein. The processor 302 may include, among other things, a clock, an arithmetic logic unit (ALU) and logic gates configured to support operation of the processing circuitry.

The communication interface 304 may be any means such as a device or circuitry embodied in either hardware or a combination of hardware and software that is configured to receive and/or transmit data, including media content in the form of video or image files, one or more audio tracks or the like. In this regard, the communication interface 304 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, the VR/AR circuitry 308 may include hardware components configured to render a datacenter visualization as described above. In some embodiments, the datacenter visualization generated by the server 300 may be rendered by the server 300 for viewing by a user. As such, in such an embodiment, the VR/AR circuitry 308 may include any device, module, component, etc. configured to render the datacenter visualization. In other embodiments, the one or more user device(s) 202 may be configured to render the datacenter visualization in an VR and/or AR environment. As such, in such an embodiment, the server 300 may generate the datacenter visualization in a format, form, or the like such that, when received by the user device(s) 202, the user device(s) 202 may render the datacenter visualization for viewing by an associated user. The VR/AR circuitry 308 may utilize processing circuitry, such as the processor 302, to perform its corresponding operations, and may utilize memory 306 to store collected information.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the server 300 may provide or supplement the functionality of particular circuitry.

### Example Method for Datacenter Visualization

FIG. 4 illustrates a flowchart containing a series of operations for datacenter visualization (e.g., method 400). The operations illustrated in FIG. 4 may, for example, be performed by, with the assistance of, and/or under the control of an apparatus (e.g., server 300), as described above. In this regard, performance of the operations may invoke one or more of processor 302, memory 306, communication interface 304, and/or VR/AR circuitry 308.

As shown in operation 402, the apparatus (e.g., server 300) includes means, such as communication interface 304, or the like, for receiving a request for datacenter visualization. The request received at operation 402 may be associated with a plurality of datacenter computing components of a physical datacenter installation, such as the example installation 100 of FIG. 1A. The request for datacenter visualization may be, for example, associated with the design of a forthcoming datacenter installation such that the operations of FIG. 4 occur as part of a pre-deployment of the physical datacenter installation. As such, the request received at operation 402 may be received from a user, operator, etc. associated with the design of the physical datacenter installation. As described above with reference to FIGS. 1A-1B, the physical datacenter installation (e.g., installation 100) may be formed of or otherwise include a plurality of datacenter computing components (e.g., racks, switches, GPUs 110, etc.) configured to collectively perform the operations associated with the physical datacenter installation.

In other embodiments, the request received at operation 402 may be associated with a physical datacenter installation that is at least partially deployed. By way of example, a physical datacenter installation that is at least partially installed may be expanded, improved, or otherwise modified by the operations described herein. As such, the request received at operation 402 may refer to a datacenter visualization that is at least partially representative of a physical datacenter installation that is at least partially deployed. In other words, the datacenter visualization in such an embodiment may facilitate partial design of a physical datacenter installation and/or modification of an existing physical datacenter installation.

Thereafter, as shown in operation 404, the apparatus (e.g., server 300) includes means, such as processor 302, communication interface 304, or the like, for determining one or more installation characteristics associated with the physical datacenter installation. As described herein, the physical datacenter installation may include a plurality of datacenter computing components (e.g., central processing units (CPUs), data processing units (DPUs), GPUs, servers, racks, switches, etc.), and the arrangement of the various datacenter computing components that form the physical datacenter installation 100 may vary based upon the number or amount of datacenter computing components (e.g., racks 102, networking/computing boxes 104, GPUs, servers, etc.) and/or the features associated with the installation location (e.g., the size, shape, geometry, etc. associated with the location at which the datacenter is installed). By way of a particular, non-limiting example, the installation characteristics determined at operation 404 may refer to the number of datacenter computing components, the type(s) of datacenter computing components, the relative distance between datacenter computing components and/or the groupings of datacenter computing components, the thermal management type (e.g., air cooling, liquid cooling, immersion cooling, etc.), the geometry of the installation location, and/or the like. The present disclosure contemplates that the installation characteristics described herein may refer to any parameter, attribute, etc. associated with a physical datacenter installation without limitation.

In some embodiments, the determination of the one or more installation characteristics may occur in response to one or more user inputs. By way of example, such as in instances in which the operations of FIG. 4 are associated with a design of a datacenter installation in the pre-deployment stage, a user may input various selections (e.g., the number of computing components, the dimensions of the installation location, the type of thermal management, etc.) that may be used to determine the one or more installation characteristics. In other embodiments, the server 300 may determine the one or more installation characteristics automatically (e.g., without explicit user inputs providing the installation characteristics). By way of example, a user may provide intended operations, performance, etc. associated with the intended physical datacenter installation, and the server 300 may determine the number of datacenter computing components (e.g., GPUs or the like) required to perform the intended operations and/or to achieve the associated performance. By way of an additional example, the server 300 may receive an indication of the location at which the physical datacenter installation will be installed (e.g., global positioning system (GPS) coordinates, building location, etc.) and determine the installation characteristics (e.g., geometry, dimensions, etc.) associated with the installation location.

Thereafter, as shown in operation 406, the apparatus (e.g., server 300) includes means, such as processor 302, communication interface 304, or the like, for determining one or more performance parameters associated with the physical datacenter installation based at least in part on the one or more installation characteristics. As would be evident to one of ordinary skill in the art in light of the present disclosure, the installation characteristics determined at operation 404 may implicate or otherwise impact one or more performance parameters associated with the physical datacenter installation. By way of example, increasing the number of datacenter computing components (e.g., GPUs, networking/computing boxes, or the like) may increase performance parameters such as cumulative processing power, processing speed, etc. associated with the physical datacenter installation. In such an example embodiment, however, an increase in the number of datacenter computing components may decrease the available space between datacenter computing components within the physical datacenter installation. By way of a particular example, increasing the number of racks 102 within the installation 100 may decrease the distances 106, 108. Such a decrease in distance between datacenter computing components may increase the thermal burden associated with these components (e.g., by reducing the space available for thermal management devices) and/or reduce the serviceability associated with these components (e.g., by reducing the space to access these components once deployed). In some embodiments, the determination of particular installation characteristics may limit or prevent the use of some features of the datacenter, such as particular geometries limiting the ability of the datacenter to employ immersion cooling. In contrast, some particular installation characteristics (e.g., a sufficient spacing between datacenter computing components) may be determined in part to provide for particular features, such as immersion cooling.

The one or more performance parameters determined at operation 406 may, in some embodiments, be device-specific or otherwise pertain to a portion of the datacenter computing components. By way of example, in some embodiments, the one or more performance parameters may indicate a particular thermal burden, serviceability metric, processing power, and/or the like associated with particular datacenter computing components within the physical datacenter installation. In other embodiments, the one or more performance parameters may be associated with a portion of the datacenter computing components and/or the entire datacenter installation. Given that the operations of FIG. 4 may occur prior to deployment of the physical datacenter installation, the installation characteristics, and by association the one or more performance parameters, may be dynamically modified or otherwise varied. As described hereafter with reference to FIG. 5, a user may, as part of designing a datacenter, modify the installation characteristics (e.g., the number/type of computing components, the relative distance between components, etc.). Such a modification may further modify the one or more performance parameters associated with the physical datacenter installation (e.g., the subsequent datacenter that is installed based upon the design).

Thereafter, as shown in operation 408, the apparatus (e.g., server 300) includes means, such as processor 302, communication interface 304, or the like, for generating the datacenter visualization for presentation to a user associated with the request. As described herein, the datacenter visualization may be a digital representation of the physical datacenter installation. For example, the datacenter visualization may refer to a digital rendering, mapping, illustration, image, or other visual representation of the physical datacenter that will be installed (e.g., in a pred-deployment implementation). In some embodiments the digital representation of the physical datacenter installation as defined by the datacenter visualization may include a visual representation of the performance parameters associated with the plurality of datacenter computing components. By way of example, the rendering or illustration of the physical datacenter installation may include images, notes, callouts, summaries, and/or other indicators illustrating the processing power, the serviceability, thermal burden, and/or the like associated with various datacenter computing components. In some embodiments, the datacenter visualization may further include a visual representation of the one or more installation characteristics associated with the physical datacenter installation. By way of example, the digital representation of the physical datacenter installation may include images, notes, callouts, summaries, and/or other indicators illustrating the number/type of datacenter computing components, the relative distance between these components, the thermal management devices servicing these components, and/or the like.

The present disclosure contemplates that the datacenter visualization may include any type, format, orientation, etc. associated with digital representations and may further be configured to receive user inputs. As described hereafter, the datacenter visualization may be configured to receive a user input that modifies one or more of the installation characteristics (e.g., repositioning a datacenter computing component, modifying a number/type of the datacenter computing component, etc.). Such a modification may be received directly within the digital representation of the physical datacenter installation.

In some embodiments, as shown in operations 410, 412, the apparatus (e.g., server 300) includes means, such as processor 302, communication interface 304, VR/AR circuitry 308, or the like, for rendering the datacenter visualization as an augmented reality (AR) overlay via a user device associated with the user and/or rendering the datacenter visualization in a virtual reality (VR) environment. As described above, virtual reality refers to any simulated experience within which a user (e.g., a user associated with the user device(s) 202) may be at least partially immersed. For example, a virtual reality rendering may refer to a computer-generated environment within which a user may immersed and with which a user my interact, such as via one or more VR devices (e.g., VR headset, VR mounted displayed, etc.). Additionally, augmented reality refers to any simulated or interactive experience that includes computer-generated content in conjunction with the real world environment. For example, an augmented reality rendering may refer to computer-generated visual, auditory, and/or other sensor information that is overlayed over a user's (e.g., a user associated with the user device(s) 202) environment.

By way of example, the datacenter visualization may, in operation 410, refer to data configured to generate and/or render (by the server 300 alone or with the assistance of the user device(s) 202) an AR overlay that is presented in the user's field of view (FOV) via smart glasses or the like. By way of a particular example, in some instances, the user may be physically located at the location at which the datacenter will be subsequently installed. In such an example, the datacenter visualization may refer to an AR overlay that presents datacenter computing components at respective locations within the physical location. Additionally or alternatively, the datacenter visualization may refer to a VR environment in operation 412 within which the user is immersed. In such an example, the VR environment may be configured such that the user is immersed in the digital representation of the physical datacenter installation.

FIG. 5 illustrates a flowchart containing a series of operations for installation arrangement and modification (e.g., method 500). The operations illustrated in FIG. 5 may, for example, be performed by, with the assistance of, and/or under the control of an apparatus (e.g., server 300), as described above. In this regard, performance of the operations may invoke one or more of processor 302, memory 306, communication interface 304, and/or VR/AR circuitry 308.

As shown in operation 502, the apparatus (e.g., server 300) includes means, such as processor 302, communication interface 304, or the like, for accessing one or more initial installation arrangements. In some embodiments, the generation of the datacenter visualization may leverage one or more prior operations of the server 300 in datacenter design and/or determined datacenter architectures (e.g., initial installation arrangements). For example, the server 300 may store (e.g., via one or more repositories or the like) or otherwise access one or more datacenter or network architectures that at least initially define installation characteristics, such as the number/type of datacenter computing components and/or their relative positions. In some embodiments, the datacenter visualization may initially comprise the initial installation arrangement in that a previously determined datacenter architecture is digitally presented to the user for modification as described hereafter.

Thereafter, as shown in operation 504, the apparatus (e.g., server 300) includes means, such as processor 302, communication interface 304, or the like, for modifying the one or more initial installation arrangements based upon the one or more installation characteristics associated with the physical datacenter installation. By way of continued example, the initial installation arrangement may refer to a previously-determined or designed network architecture. This initial arrangement may operate as a basis or template through which the user may input modifications. In some embodiments, however, the initial installation arrangement may be used as the basis for the datacenter visualization without explicit modification by the user in that the installation characteristics that are determined by the server 300 at operation 404 may be used to modify the initial installation arrangement as an internal process or the server (e.g., to reduce the computational/processing burden on the server 300).

In some embodiments, as shown in operation 506, the apparatus (e.g., server 300) includes means, such as processor 302, VR/AR circuitry 308, or the like, for receiving one or more modifications to the installation characteristics. As described above, in some embodiments, the datacenter visualization may be presented to the user for review (e.g., via a VR/AR rendering or otherwise), and the user may input various modifications to the installation characteristics. By way example, the user may initially provide various installation characteristics, such as those described above with reference to FIG. 4, and the server 300 may generate a datacenter visualization that is based upon these inputted installation characteristics. In reviewing the datacenter visualization and the visual representation of the one or more performance parameters associated with the physical datacenter installation, the user may operate to modify various installation characteristics in order to visualize the impact of these modifications on the performance parameters of the physical datacenter installation.

The user may, for example, review the one or more performance parameters visually represented by the datacenter visualization and identify one or more parameters for modification. By way of a particular, non-limiting example, the user may identify an increased thermal burden and/or reduced serviceability of particular datacenter computing components as illustrated by the datacenter visualization. In response, the user may modify one or more installation characteristics (e.g., the relative distance between these components, the thermal management devices deployed, and/or the like) in order to address these one or more performance parameters. In response, as shown in operation 508, the apparatus (e.g., server 300) includes means, such as processor 302, VR/AR circuitry 308, or the like, for dynamically modifying the datacenter visualization based upon the one or more modifications. For example, the server 300 may receive a modification that modifies the relative distance between datacenter computing components (e.g., an associated installation characteristic) and modifies the digital representation of these components to reflect this change. In some embodiments, the one or more modifications to the installation characteristics are received via a user input directly within a virtual reality (VR) environment or an augmented reality (AR) overlay rendering the datacenter visualization. For example, the user may, within the VR/AR rendering, adjust the physical location of one or more datacenter computing components (e.g., racks, switches, etc.)

Thereafter, as shown in operation 510, the apparatus (e.g., server 300) includes means, such as processor 302, VR/AR circuitry 308, or the like, for dynamically determining the one or more performance parameters associated with the physical datacenter installation in response to the one or more modifications to the installation characteristics. By way of continued example, the modification to the one or more installation characteristics may implicate, impact, or otherwise adjust the one or more performance of the physical datacenter installation. In order to provide a digital representation with which the user may dynamically interact, the server 300 may dynamically update, adjust, modify, etc. the one or more performance parameters that are visually represented by the datacenter visualization. The dynamic determination of the one or more performance parameters and the subsequent modification of the datacenter visualization may occur in real or substantially real-time. By way of example, a user may interact directly with the datacenter visualization via a VR/AR rending and may actively adjust the position of one or more of the datacenter computing components. In real or substantially real-time, the server 300 may determine the one or more performance parameters impacted by this modification and actively, dynamically, and/or iteratively update the datacenter visualization. As described above, the datacenter visualizations described herein may further be used to train users, operators, technicians, servicers, etc. by providing a digital representation of the physical datacenter installation with which these users may interact.

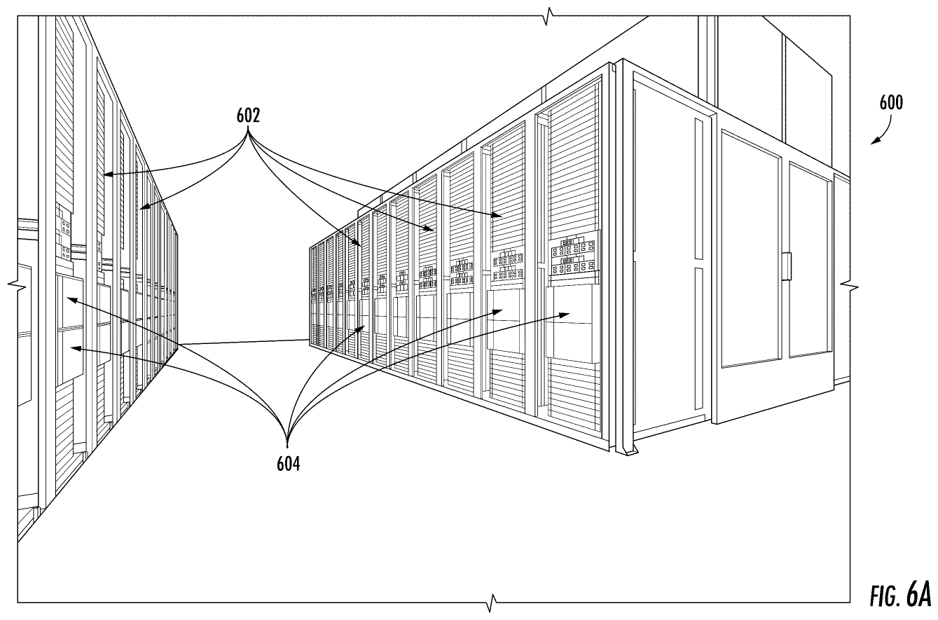

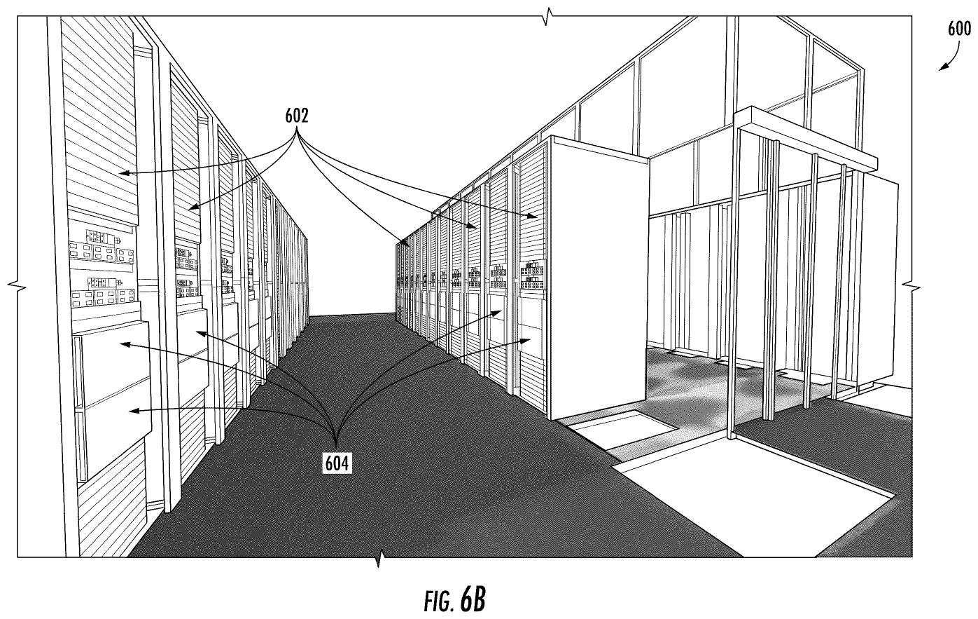

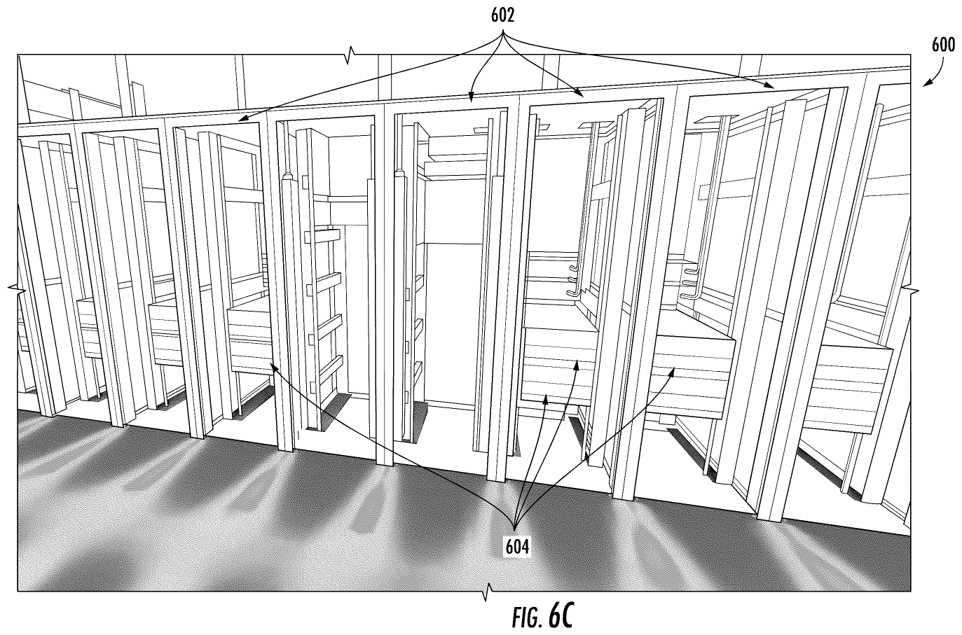

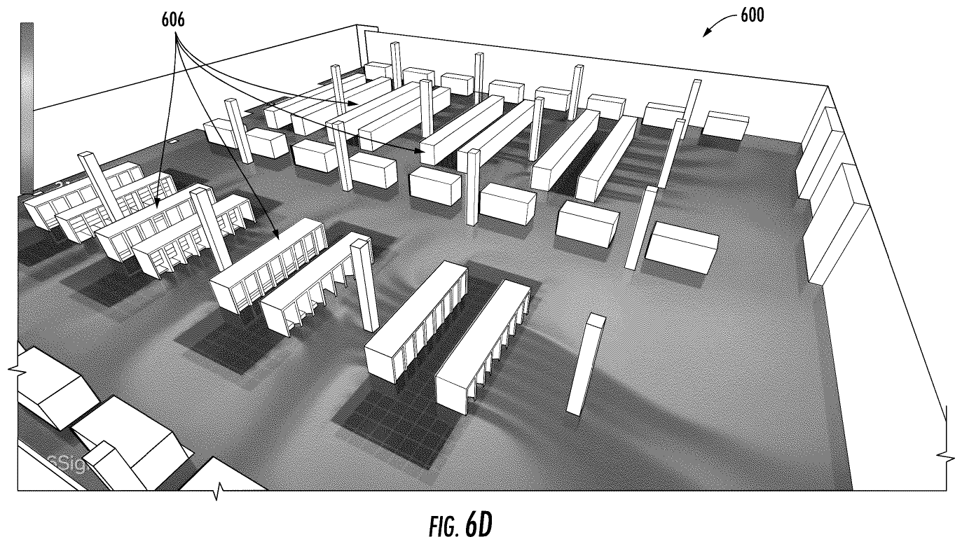

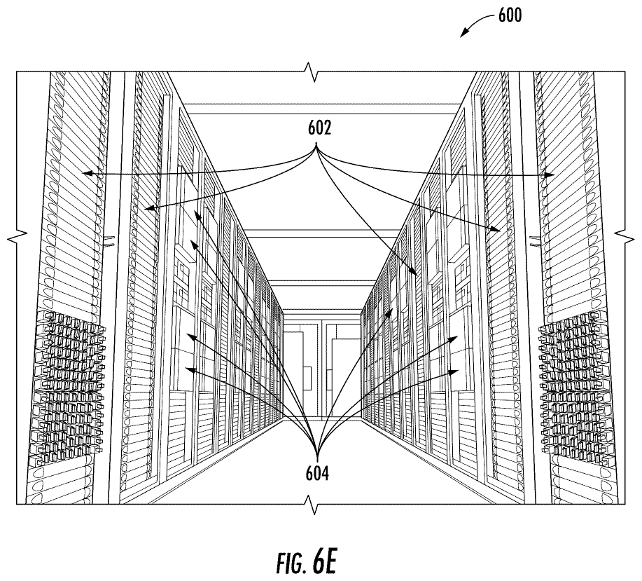

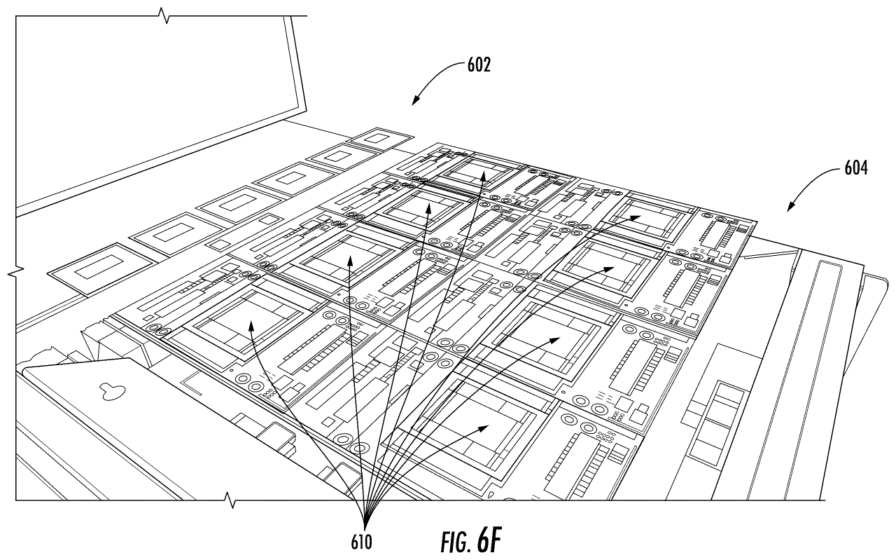

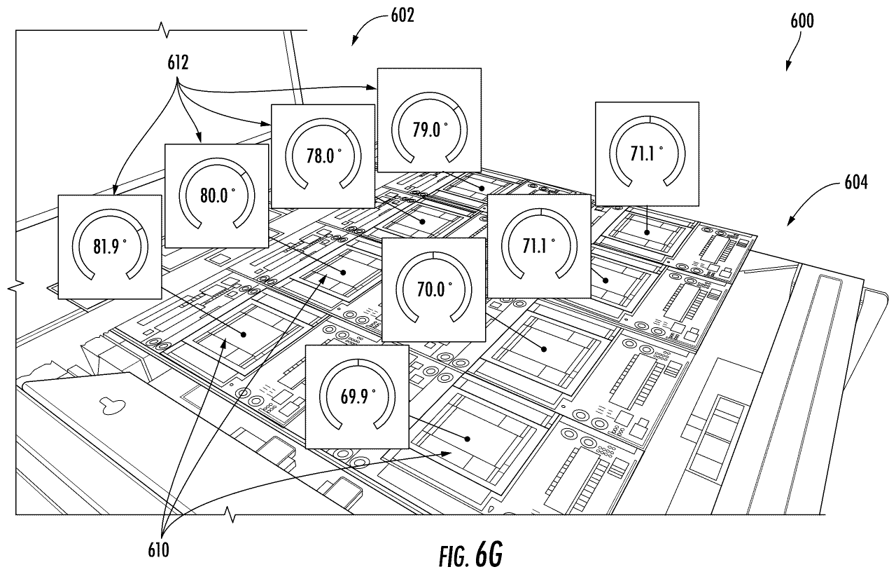

With reference to FIGS. 6A-6G, example datacenter visualizations 600 generated by the methods described above are illustrated. As shown, the datacenter visualization 600 may be a digital representation of the physical datacenter installation. As such, the datacenter visualization 600 may refer to a digital rendering, mapping, illustration, image, or other visual representation of the physical datacenter that will be installed (e.g., in a pred-deployment implementation or otherwise). The datacenter visualization 600 may, for example, include a digital representation of a plurality of datacenter racks 602 supporting or otherwise formed of digital representations of one or more networking boxes 604 (e.g., servers, computing devices, etc.). As shown in FIG. 6D, the digital representations of the plurality of datacenter racks 602 may be grouped (e.g., grouped racks 606) in various rows representative of the orientation/configuration of the physical datacenter installation represented by the datacenter visualization 600. In other words, the datacenter visualization 600 may operate as a digital twin of the physical datacenter installation.

With reference to FIGS. 6F-6G, an example networking/computing box 604 is illustrated as an example datacenter computing component of the datacenter visualization 600. By way of example, the visual representation of the networking/computing box 604 may digitally illustrate a networking enclosure that supports a plurality of GPUs 610 as part of a high-performance computing system. Although described herein with reference to GPU(s) 610 as example datacenter computing components that are visually presented to the user via the datacenter visualization, the present disclosure contemplates that any device, element, feature, etc. (e.g., CPU, DPU, optical components, switches, and/or the like.) may be represented in the datacenter visualization. As shown in FIG. 6G, in some embodiments, the digital representation of the physical datacenter installation as defined by the datacenter visualization 600 may include a visual representation of the performance parameters 612 associated with the plurality of datacenter computing components 610. By way of example, the rendering or illustration of the physical datacenter installation may include images, notes, callouts, summaries, and/or other indicators illustrating the processing power, the serviceability, thermal burden, and/or the like associated with various datacenter computing components. In some embodiments, the datacenter visualization 600 may further include a visual representation of the one or more installation characteristics associated with the physical datacenter installation. By way of example, the digital representation of the physical datacenter installation may include images, notes, callouts, summaries, and/or other indicators illustrating the number/type of datacenter computing components, the relative distance between these components, the thermal management devices servicing these components, and/or the like.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to a network interface environment, however, one skilled in the art may recognize that such principles may be applied to any scheduler receiving commands and/or transactions and having access to two or more processing cores. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

That which is claimed is:

1. A computer-implemented method comprising:
receiving a request for datacenter visualization, wherein the request is associated with a plurality of datacenter computing components of a physical datacenter installation;
determining one or more installation characteristics associated with the physical datacenter installation;
determining one or more performance parameters associated with the physical datacenter installation based at least in part on the one or more installation characteristics; and
generating the datacenter visualization for presentation to a user associated with the request, wherein the datacenter visualization is a digital representation of the physical datacenter installation that further includes a visual representation of the performance parameters associated with the plurality of datacenter computing components.

2. The computer-implemented method according to claim 1, further comprising rendering the datacenter visualization in a virtual reality (VR) environment.

3. The computer-implemented method according to claim 1, further comprising rendering the datacenter visualization as an augmented reality (AR) overlay via a user device associated with the user.

4. The computer-implemented method according to claim 1, wherein generating the datacenter visualization further comprises:
accessing one or more initial installation arrangements; and
modifying the one or more initial installation arrangements based upon the one or more installation characteristics associated with the physical datacenter installation.

5. The computer-implemented method according to claim 1, further comprising:
receiving one or more modifications to the installation characteristics; and
dynamically modifying the datacenter visualization based upon the one or more modifications.

6. The computer-implemented method according to claim 5, further comprising:
dynamically determining the one or more performance parameters associated with the physical datacenter installation in response to the one or more modifications to the installation characteristics.

7. The computer-implemented method according to claim 5, wherein the one or more modifications to the installation characteristics are received via a user input directly within a virtual reality (VR) environment or an augmented reality (AR) overlay rendering the datacenter visualization.

8. A system comprising:
a non-transitory storage device; and
a processor coupled to the non-transitory storage device, wherein the processor is configured to:
receive a request for datacenter visualization, wherein the request is associated with a plurality of datacenter computing components of a physical datacenter installation;
determine one or more installation characteristics associated with the physical datacenter installation;
determine one or more performance parameters associated with the physical datacenter installation based at least in part on the one or more installation characteristics; and
generate the datacenter visualization for presentation to a user associated with the request, wherein the datacenter visualization is a digital representation of the physical datacenter installation that further includes a visual representation of the performance parameters associated with the plurality of datacenter computing components.

9. The system according to claim 8, wherein the processor is further configured to render the datacenter visualization in a virtual reality (VR) environment.

10. The system according to claim 8, wherein the processor is further configured to render the datacenter visualization as an augmented reality (AR) overlay via a user device associated with the user.

11. The system according to claim 8, wherein, in generating the datacenter visualization, the processor is further configured to:
access one or more initial installation arrangements; and
modify the one or more initial installation arrangements based upon the one or more installation characteristics associated with the physical datacenter installation.

12. The system according to claim 8, wherein the processor is further configured to:
receive one or more modifications to the installation characteristics; and
dynamically modify the datacenter visualization based upon the one or more modifications.

13. The system according to claim 12, wherein the processor is further configured to:
dynamically determine the one or more performance parameters associated with the physical datacenter installation in response to the one or more modifications to the installation characteristics.

14. The system according to claim 12, wherein the one or more modifications to the installation characteristics are received via a user input directly within a virtual reality (VR) environment or an augmented reality (AR) overlay rendering the datacenter visualization.

15. A computer program product comprising at least one non-transitory computer-readable storage medium having computer program code thereon that, in execution with at least one processor, configures the computer program product for:
receiving a request for datacenter visualization, wherein the request is associated with a plurality of datacenter computing components of a physical datacenter installation;
determining one or more installation characteristics associated with the physical datacenter installation;
determining one or more performance parameters associated with the physical datacenter installation based at least in part on the one or more installation characteristics; and
generating the datacenter visualization for presentation to a user associated with the request, wherein the datacenter visualization is a digital representation of the physical datacenter installation that further includes a visual representation of the performance parameters associated with the plurality of datacenter computing components.

16. The computer program product according to claim 15, further configured for rendering the datacenter visualization in a virtual reality (VR) environment and/or rendering the datacenter visualization as an augmented reality (AR) overlay via a user device associated with the user.

17. The computer program product according to claim 15, wherein, in generating the datacenter visualization, the computer program product is further configured for:
accessing one or more initial installation arrangements; and
modifying the one or more initial installation arrangements based upon the one or more installation characteristics associated with the physical datacenter installation.

18. The computer program product according to claim 15, further configured for:
receiving one or more modifications to the installation characteristics; and
dynamically modifying the datacenter visualization based upon the one or more modifications.

19. The computer program product according to claim 18, further configured for:
dynamically determining the one or more performance parameters associated with the physical datacenter installation in response to the one or more modifications to the installation characteristics.

20. The computer program product according to claim 18, wherein the one or more modifications to the installation characteristics are received via a user input directly within a virtual reality (VR) environment or an augmented reality (AR) overlay rendering the datacenter visualization.
